(19) United States
(12) Patent Application Publication
(10) Pub. No.: US 2017/0279688 A1
(43) Pub. Date: Sep. 28, 2017

(54) METHOD, DEVICE AND SYSTEM FOR PROVIDING DEVICE APPLICATION SOFTWARE MANAGEMENT SERVICE IN INTERNET OF THINGS

(71) Applicant: ZTE Corporation, Shenzhen (CN)

(72) Inventor: Weixiang SHAO, Shenzhen (CN)

(21) Appl. No.: 15/508,657

(22) PCT Filed: Apr. 29, 2015
(86) PCT No.: PCT/CN2015/077875

§ 371 Date: Mar. 3, 2017

(30) Foreign Application Priority Data
Sep. 4, 2014 (CN) 201410449624.1

(51) Int. Cl. H04L 12/24; H04L 29/08

(52) U.S. Cl. CPC H04L 41/20; H04L 67/12; H04L 67/34

(57) ABSTRACT

A method, device and system for providing a device application software management service in Internet of things are provided. In the method, a management operation or capability of a device application software management service requested by an application entity is received, a requested target device is managed according to the management operation or capability of the device application software management service, and the application entity is provided with an operation result and/or an operation state.

### TECHNICAL FIELD

The present disclosure relates to the field of communications, and in particular to a method, device and system for providing a device application software management service in the Internet of things.

### BACKGROUND

Internet of things is an important constituent part of a new generation of information technologies. As the name implies, the Internet of things is an internet in which things are interconnected. An international telecommunications union (ITU) internet report issued by the ITU defines the Internet of things as follows. By virtue of information sensing devices such as a two-dimensional code identification device, a radio-frequency identification device (RFID), an infrared sensor, a global positioning system and a laser scanner etc., any objects can be connected to the internet according to an agreed protocol. In the network formed in such a manner, information can be exchanged and communication can be conducted, so as to realize intelligent identification, positioning, tracking, monitoring and managing.

A concept of M2M is usually introduced in the Internet of things, which may be interpretated as man to man, man to machine, and/or machine to machine. Essentially, the interaction of man to machine and machine to machine mostly aims at realizing an information interaction of man to man. The M2M network is a main form of the Internet of things currently, and includes a machine to machine communication network, a man to machine communication network and a machine to man communication network. The devices in the M2M network mainly include M2M terminals, M2M gateways and M2M servers.

FIG. 1 shows a diagram of a system of the Internet of things in related art. As shown in FIG. 1, the Internet of things can be classified into a private Internet of things (generally providing services for a single institution), a public Internet of things (providing services for the public or a large-scale user group), a community Internet of things (providing services for an associated “community” or an institutional group) etc. Currently the Internet of things has been widely applied in different industries, including intelligent agriculture, smart grid, intelligent transportation, intelligent logistics, intelligent healthcare, and smart home etc. Especially, these industries have been deployed with their own professional Internet of things, including corresponding professional Internet of things/M2M devices (such as terminals and gateways) and platform devices (such as server and the like).

Telecom operator, as a provider of public communication services, also plays a role of a public Internet of things server when providing the Internet of things/M2M service. As for the devices in the private Internet of things, the public Internet of things, the community Internet of things and a professional Internet of things of each industry, current telecom operator, acting as the public Internet of things server, lacks an effective technical solution to uniformly manage the devices and realize the services.

As for the problem that devices of the public Internet of things and other Internet of things cannot be managed uniformly in related art, there is no effective technical solution currently.

### SUMMARY

Embodiments of the present disclosure provide a method, device and system for providing a device application software management service in the Internet of things, to at least solve the problem that devices of the public Internet of things and other Internet of things cannot be managed uniformly in related art.

An embodiment of the present disclosure provides a method for providing a device application software management service in Internet of things, including: a management operation or capability of a device application software management service requested by an application entity is received, a requested target device is managed according to the management operation or capability of the device application software management service, and an operation result and/or an operation state is provided to the application entity.

In an exemplary embodiment, the target device may include at least one of the follows: a single device, multiple devices indicated in a list, and a device group.

In an exemplary embodiment, in a process of managing the requested target device according to the management operation or capability of the device application software management service, the method may include: executing the management operation or capability of the device application software management service based on scheduling.

In an exemplary embodiment, a message exchange mode used by the management operation or capability of the device application software management service may include at least one of the follows: a requesting and responding mode of receiving a request and sending a response synchronously; and a requesting and asynchronously informing mode of reporting to the application entity after an operation is completed.

In an exemplary embodiment, the management operation or capability of the device application software management service may include: obtaining application software information; wherein input information of obtaining the application software information may include: a device identifier; return information of obtaining the application software information may include at least one of the follows: a response type, a software version, a software name, a software packet uniform resource locator, an installation state and an activation state.

In an exemplary embodiment, the management operation or capability of the device application software management service may include: downloading application software; wherein input information of downloading the application software may include at least one of the follows: a device identifier, a software version, a software name and a software packet uniform resource locator; and return information of downloading the application software may include: a response type.

In an exemplary embodiment, the management operation or capability of the device application software management service may include: installing application software; wherein input information of installing the application software may include at least one of the follows: a device identifier, a software version and a software name; and return information of installing the application software may include at least one of the follows: a response type and an installation state.

In an exemplary embodiment, the management operation or capability of the device application software management service may include: deleting application software; wherein input information of deleting the application software may include at least one of the follows: a device identifier, a software version and a software name; and return information of deleting the application software may include at least one of the follows: a response type and an installation state.

In an exemplary embodiment, the management operation or capability of the device application software management service may include: activating application software; wherein input information of activating the application software may include at least one of the follows: a device identifier, a software version and a software name; and return information of activating the application software may include at least one of the follows: a response type, and an activation state.

In an exemplary embodiment, the management operation or capability of the device application software management service may include: deactivating application software; wherein input information of deactivating the application software may include at least one of the follows: a device identifier, a software version and a software name; and return information of deactivating the application software may include at least one of the follows: a response type, and an activation state.

In an exemplary embodiment, the management operation or capability of the device application software management service may include: reporting an application software state; wherein input information of reporting the application software state may include at least one of the follows: a final reporting mark, a sequence number, an application software reporting list and an aggregation strategy; the application software reporting list may include one or more application software reports, and each application software report may include at least one of the follows: a group identifier, a device identifier, a management operation, an operation result, an installation state and an activation state; the management operation may include at least one of the follows: downloading application software, installing application software, deleting application software, activating application software, and deactivating application software; and the return information of reporting application software state may include a response type.

In an exemplary embodiment, the installation state may include at least one of the follows: installation success, installing, installation failed, deletion success, deleting, and deletion failed.

In an exemplary embodiment, the activation state may include at least one of the follows: activation success, activating, activation failed, deactivation success, deactivating, and deactivation failed.

In an exemplary embodiment, in a process of receiving the management operation or capability of the device application software management service requested by the application entity may include: adapting the management operation or capability of the device application software management service to a corresponding technical operation of a device management server.

In an exemplary embodiment, the device management server may include a device management server in an underlying network of a public Internet of things domain or a device management server in other service provider domains.

In an exemplary embodiment, the device management server uses at least one of the following technologies: an extensible messaging and presence protocol (XMPP), a message queuing telemetry transport (MQTT), an open mobile alliance device management protocol (OMA DM), a broadband forum customer premise equipment wide area network management protocol (BBF CWMP), and an open mobile alliance lightweight machine to machine protocol (OMA lightweight M2M).

Another embodiment of the present disclosure provides a device for providing a device application software management service in Internet of things, including: a managing module, arranged to receive a management operation or capability of a device application software management service requested by an application entity, and manage a requested target device according to the management operation or capability of the device application software management service; and a feedback module, arranged to provide the application entity with an operation result and/or an operation state.

In an exemplary embodiment, the target device may include at least one of the follows: a single device, multiple devices indicated in a list, and a device group.

In an exemplary embodiment, the managing module is further arranged to execute the management operation or capability of the device application software management service based on scheduling.

In an exemplary embodiment, the managing module is further arranged to adapt the management operation or capability of the device application software management service to a corresponding technical operation of a device management server.

In an exemplary embodiment, the device management server may include a device management server in an underlying network of a public Internet of things domain or a device management server in other service provider domains.

Another embodiment of the present disclosure provides a system for providing a device application software management service in Internet of things, including: an application entity, arranged to request a management operation or capability of a device application software management service; a general service entity, arranged to receive the management operation or capability of the device application software management service requested by the application entity, manage a requested target device according to the management operation or capability of the device application software management service; and provide the application entity with an operation result and/or an operation state.

In an exemplary embodiment, further including a management adapter, arranged to adapt the management operation or capability of the device application software management service to a corresponding technical operation of a device management server.

According to the technical solution of the embodiments of the present disclosure, a management operation or capability of a device application software management service requested by an application entity is received, a requested target device is managed according to the management operation or capability of the device application software management service, and the application entity is provided with an operation result and/or an operation state. The technical solution solves the problem that devices of the public Internet of things and other Internet of things cannot be managed uniformly in related art, and realizes the management on the device application software management service.

### BRIEF DESCRIPTION OF THE DRAWINGS

The drawings here are used for further describing the present disclosure, be part of the present disclosure, the embodiments and description thereof are used for describing the present disclosure, and not intended to limit the present disclosure. In drawings:

FIG. 1 shows a diagram of a system of the Internet of things in related art;

FIG. 2 shows a flowchart of a method for providing a device application software management service in Internet of things in an embodiment of the present disclosure;

FIG. 3 shows a structural diagram of a device for providing a device application software management service in Internet of things in an embodiment of the present disclosure;

FIG. 4 shows a structural diagram of a system for providing a device application software management service in Internet of things in an embodiment of the present disclosure;

FIG. 5 shows a flowchart of a first method for providing a device application software management service in Internet of things in an exemplary embodiment of the present disclosure;

FIG. 6 shows a flowchart of a second method for providing a device application software management service in Internet of things in an exemplary embodiment of the present disclosure.

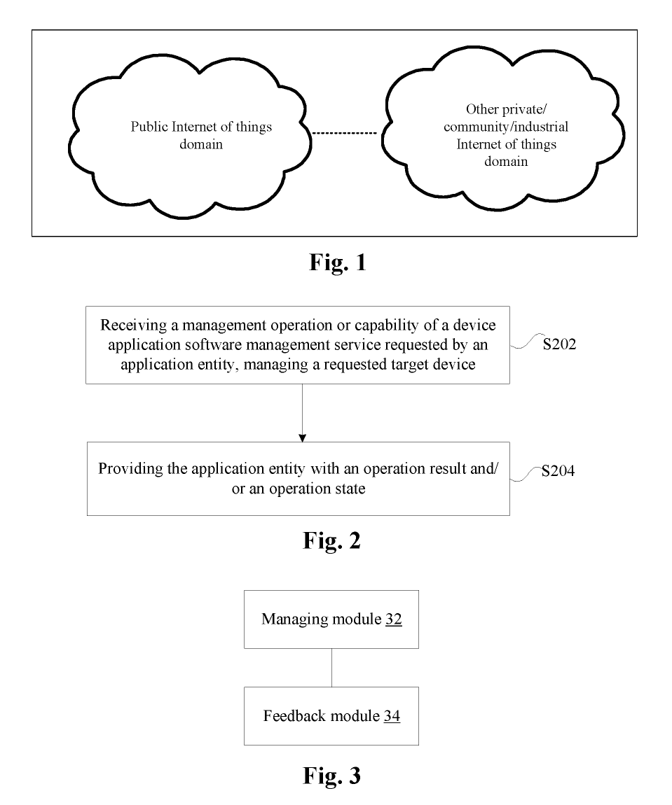

### DETAILED DESCRIPTION OF THE EMBODIMENTS

The present disclosure is further described below with reference to the drawings and the embodiments. It is important to note that the embodiments and characteristics in the embodiments of the present disclosure can be combined mutually when no conflict exists.

A general service entity and an application entity mentioned in the following embodiments are described in a patent application for invention with the application number of 2014101273881.1 and the invention name of “M2M application service method, device and system”, and not repeated here again.

A device in Internet of things in the embodiments of the present disclosure may include at least one of the follows: a M2M terminal, a M2M gateway and a M2M server.

In an embodiment below, the M2M terminal may be a mobile terminal (such as a phone, a tablet computer etc.), or other type of terminals capable of accessing the Internet of things. An operation system running in the terminal may be all kinds of systems, for example, an Android system used widely at present, or a windows operation system, an iOS system etc., but not limited to these. The devices may be servers, various kinds of gateways, or other types of devices.

The terminal or device may include a storage medium, and program units stored in the storage medium can be used for implementing the method described in the embodiments below. The terminal or device may further include a processor, and the processor is arranged to implement the program units. It can be expected that the method or device described below can be realized through computer program units.

In the embodiment below, other Internet of things domain mentioned may be a private Internet of things providing service for a single institution, other public Internet of things and a community Internet of things. Meanwhile, the Internet of things is widely applied in different industries, including intelligent agriculture, smart grid, intelligent transportation, intelligent logistics, intelligent healthcare, and smart home etc.

FIG. 2 shows a flowchart of a method for providing a device application software management service in Internet of things in an embodiment of the present disclosure. As shown in FIG. 2, the method at least includes steps S202-S204:

S202: receiving a management operation or capability of a device application software management service requested by an application entity, managing a requested target device according to the management operation or capability of the device application software management service;

S204: providing the application entity with an operation result and/or the operation state. According to the technical solution of the embodiment of the present disclosure, a management operation or capability of a device application software management service requested by an application entity is received, a requested target device is managed according to the management operation or capability of the device application software management service, and the application entity is provided with an operation result and/or an operation state. The technical solution solves the problem that devices of the public Internet of things and other Internet of things cannot be managed uniformly in related art, and realizes the management on the device application software management service.

In an exemplary embodiment, the target device may include at least one of the follows: a single device, multiple devices indicated in a list, and a device group.

In an embodiment of the present disclosure, preferably, the management operation or capability of the device application software management service may be executed based on scheduling.

In an embodiment of the present disclosure, preferably, a message exchange mode used by the management operation or capability of the device application software management service may include at least one of the follows: a requesting and responding mode of receiving a request and sending a response synchronously; and a requesting and asynchronously informing mode of reporting to the application entity after an operation is completed.

In an embodiment of the present disclosure, preferably, the management operation or capability of the device application software management service may include: obtaining application software information; wherein input information of obtaining the application software information may include: a device identifier; return information of obtaining the application software information may include at least one of the follows: a response type, a software version, a software name, a software packet uniform resource locator, an installation state and an activation state.

In an embodiment of the present disclosure, preferably, the management operation or capability of the device application software management service may include: downloading application software; wherein input information of downloading the application software may include at least one of the follows: a device identifier, a software version, a software name and a software packet uniform resource locator; and return information of downloading the application software may include: a response type.

In an embodiment of the present disclosure, preferably, the management operation or capability of the device application software management service may include: installing application software; wherein input information of installing the application software may include at least one of the follows: a device identifier, a software version and a software name; and return information of installing the application software may include at least one of the follows: a response type and an installation state.

In an embodiment of the present disclosure, preferably, the management operation or capability of the device application software management service may include: deleting application software; wherein input information of deleting the application software may include at least one of the follows: a device identifier, a software version and a software name; and return information of deleting the application software may include at least one of the follows: a response type and an installation state.

In an embodiment of the present disclosure, preferably, the management operation or capability of the device application software management service may include: activating application software; wherein input information of activating the application software may include at least one of the follows: a device identifier, a software version and a software name; and return information of activating the application software may include at least one of the follows: a response type, and an activation state.

In an embodiment of the present disclosure, preferably, the management operation or capability of the device application software management service may include: deactivating application software; wherein input information of deactivating the application software may include at least one of the follows: a device identifier, a software version and a software name; and return information of deactivating the application software may include at least one of the follows: a response type, and an activation state.

In an embodiment of the present disclosure, preferably, the management operation or capability of the device application software management service may include: reporting an application software state; wherein input information of reporting the application software may include at least one of the follows: a final reporting mark, a sequence number, an application software reporting list and an aggregation strategy; the application software reporting list may include one or more application software reports, and each application software report may include at least one of the follows: a group identifier, a device identifier, a management operation, an operation result, an installation state and an activation state; the management operation may include at least one of the follows: downloading application software, installing application software, deleting application software, activating application software, and deactivating application software; and return information of reporting the application software state may include a response type.

In an embodiment of the present disclosure, preferably, the installation state may include at least one of the follows: installation success, installing, installation failed, deletion success, deleting, and deletion failed.

In an embodiment of the present disclosure, preferably, the activation state may include at least one of the follows: activation success, activating, activation failed, deactivation success, deactivating, and deactivation failed.

In an embodiment of the present disclosure, preferably, the process of responding the management operation or capability of the device application software management service requested by the application entity may include: adapting the management operation or capability of the device application software management service to a corresponding technical operation of a device management server.

In an embodiment of the present disclosure, preferably, the device management server may include a device management server in an underlying network of a public Internet of things domain or a device management server in other service provider domains.

In an exemplary embodiment, the device management server uses at least one of the following technologies: an extensible messaging and presence protocol (XMPP), a message queuing telemetry transport (MQTT), an open mobile alliance device management protocol (OMA DM), a broadband forum customer premise equipment wide area network management protocol (BBF CWMP), and an open mobile alliance lightweight machine to machine protocol (OMA lightweight M2M).

Another embodiment of the present disclosure provides a device for providing a device application software management service in Internet of things. The device is arranged to realize the embodiments and the exemplary embodiments above, and the description thereof is not repeated here again. The term “module” used below can realize a combination of software and/or hardware with a preset function. Although the device described below is preferably realized by software, but, the hardware, or the combination of the software and hardware are also possible.

FIG. 3 shows a structural diagram of a device for providing a device application software management service in the Internet of things in an embodiment of the present disclosure. As shown in FIG. 3, the device includes: a managing module 32, arranged to receive a management operation or capability of a device application software management service requested by an application entity, and manage a requested target device according to the management operation or capability of the device application software management service; and a feedback module 34, coupled to the managing module 32 and arranged to provide the application entity with an operation result and/or an operation state.

In an exemplary embodiment, the target device may include at least one of the follows: a single device, multiple devices indicated in a list, and a device group.

In an embodiment of the present disclosure, the managing module 32 is further arranged to execute the management operation or capability of the device application software management service based on scheduling.

In an embodiment of the present disclosure, the managing module 32 is further arranged to adapt the management operation or capability of the device application software management service to a corresponding technical operation of a device management server.

In an embodiment of the present disclosure, the device management server may include a device management server in an underlying network of a public Internet of things domain or a device management server in other service provider domains.

It is important to note that, in the device, the portions corresponding to the method described above are not repeated here again.

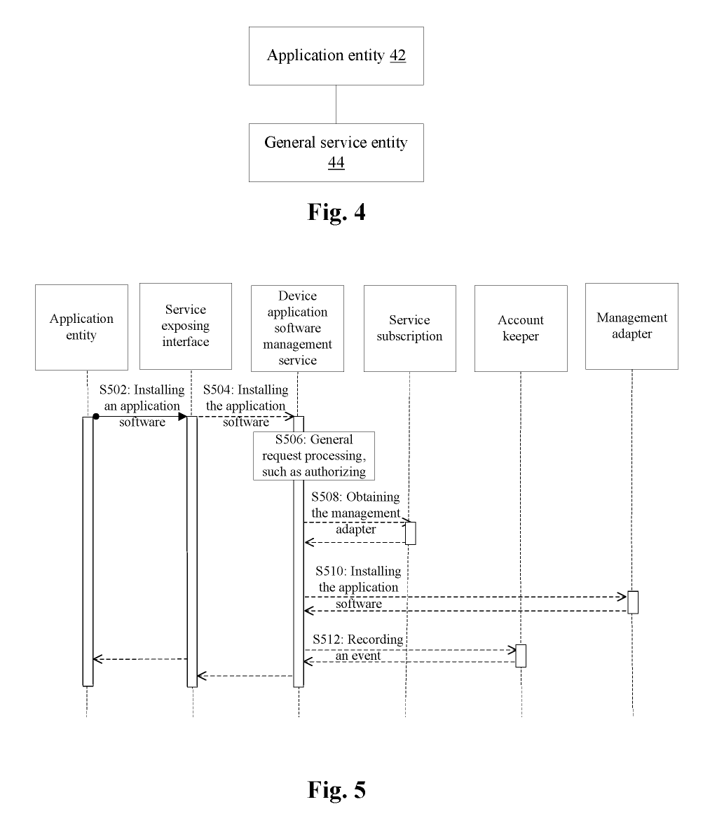

An embodiment of the present disclosure provides a system for providing a device application software management service in Internet of things. FIG. 4 shows a structural diagram of a system for providing a device application software management service in Internet of things in an embodiment of the present disclosure. As shown in FIG. 4, the system includes: an application entity 42, arranged to request a management operation or capability of a device application software management service; a general service entity 44 coupled to the application entity 42 and arranged to receive the management operation or capability of the device application software management service requested by the application entity, manage a requested target device according to the management operation or capability of the device application software management service; and provide the application entity with an operation result and/or an operation state. Specifically, the general service entity 44 may include the device application software management service device of the Internet of things shown in FIG. 3.

In an exemplary embodiment, the system may further include a management adapter, arranged to adapt the management operation or capability of the device application software management service to a corresponding technical operation of a device management server.

It is important to note that, in the system, the portions corresponding to the method described above are not repeated here again.

The exemplary embodiments of the present disclosure are described below with reference to examples. It can be understood that the exemplary embodiments are not limited to the method below. A specific structure of the general service entity in the exemplary embodiments below is described in a patent application for invention with the application number of 2014101273881.1 and the invention name of “M2M application service method, device and system”, and not repeated here again.

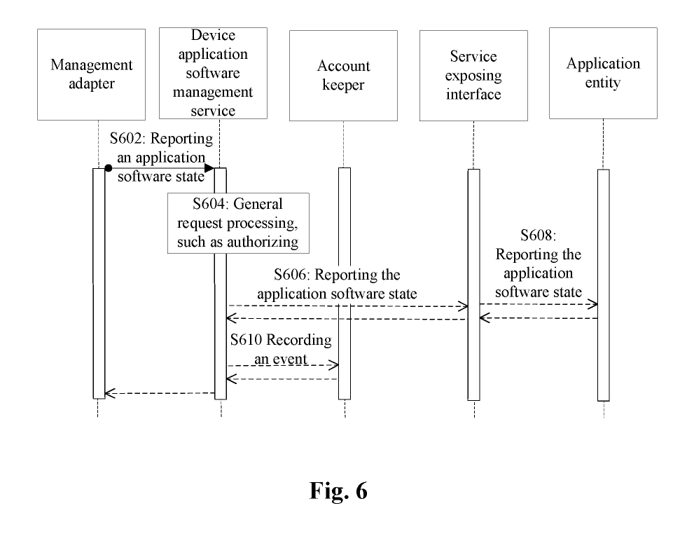

FIG. 5 shows a flowchart of a first method for providing a device application software management service in Internet of things in an exemplary embodiment of the present disclosure. As shown in FIG. 5, the method at least includes steps S502-S512:

S502: the application entity sends an application software installation request to a service exposing interface of the device application software management service;

S504: the service exposing interface transmits the application software installation request to the device application software management service;

S506: the device application software management service calls a general processing request such as authorizing;

S508: the device application software management service obtains a management adapter through a service order relation;

S510: the device application software management service sends the application software installation request to the management adapter; the management adapter subsequently uses the device management server in the underlying network of a public Internet of things domain or the device management servers in other service provider domains; the device management server can use at least one of the following technologies: the XMPP, the MQTT, the OMA DM, the BBF CWMP, and the OMA lightweight M2M.

S512: the device application software management service records an event.

FIG. 6 shows a flowchart of a second method for providing a device application software management service in Internet of things in an exemplary embodiment of the present disclosure. As shown in FIG. 6, the method at least includes steps S602-S610:

S602: the management adapter obtains an application software operation result or state report of the device management server in the underlying network of a public Internet of things domain or the device management servers in other service provider domains, and sends an application software state report inform to the device application software management service;

S604: the device application software management service calls a general processing request such as authorizing;

S606: the device application software management service transmits the application software state report inform to a service exposing interface;

S608: the service exposing interface transmits the application software state report inform to an application entity;

S610: the device application software management service records an event.

In view of the above, the embodiments of the present disclosure realize the technical effects below. The problem of how to uniformly manage the devices of the public Internet of things and other Internet of things can be solved, and the uniform application software management service on the devices of the public Internet of things and other Internet of things can be realized.

Another embodiment provides software, and the software is arranged to implement the technical solution described in the embodiments and the exemplary embodiments above.

Another embodiment provides a storage medium, and the software above is stored in the storage medium. The storage medium may include, but not limited to, a disk, a floppy disk, hard disk and an erasable memory etc.

Obviously, those skilled in the art shall understand that all of the above-mentioned modules or steps in the present disclosure may be implemented by using a general calculation apparatus, may be centralized on a single calculation apparatus or may be distributed on a network composed of multiple calculation apparatuses. Alternatively, they may be implemented by using executable program codes of the calculation apparatus. Thus, they may be stored in a storage apparatus and executed by the calculation apparatuses, the shown or described steps may be executed in a sequence different from the sequence under certain conditions, or they are manufactured into each integrated circuit module respectively, or multiple module or steps therein are manufactured into a single integrated circuit module. Thus, the present disclosure is not limited to combination of any specific hardware and software.

The above is only the exemplary embodiments of the present disclosure, and not intended to limit the present disclosure. There may be various modifications and variations in the present disclosure for those skilled in the art. Any modifications, equivalent replacements, improvements and the like made within the principle of the present disclosure shall fall within the scope of the protection defined in the appended claims of the present disclosure.

### INDUSTRIAL APPLICABILITY

As mentioned above, a method, device and system for providing a device application software management service in Internet of things provided in present disclosure can achieve the following effects. The problem that devices of the public Internet of things and other Internet of things cannot be managed uniformly in related art can be solved, and the management on the device application software management service can be realized.

1. A method for providing a device application software management service in Internet of things, comprising:
receiving a management operation or capability of a device application software management service requested by an application entity, managing a requested target device according to the management operation or capability of the device application software management service; and
providing the application entity with an operation result and/or an operation state;
wherein
the target device comprises at least one of the follows: a single device, multiple devices indicated in a list, and a device group;
in a process of managing the requested target device according to the management operation or capability of the device application software management service, the method comprises: executing the management operation or capability of the device application software management service based on scheduling;
a message exchange mode used by the management operation or capability of the device application software management service comprises at least one of the follows: a requesting and responding mode of receiving a request and sending a response synchronously; and a requesting and asynchronously informing mode of reporting to the application entity after an operation is completed.

2. (canceled)

3. (canceled)

4. (canceled)

5. The method as claimed in claim 1, wherein
the management operation or capability of the device application software management service comprises: obtaining application software information;
input information of obtaining the application software information comprises: a device identifier; and
return information of obtaining the application software information comprises at least one of the follows: a response type, a software version, a software name, a software packet uniform resource locator, an installation state and an activation state;
the management operation or capability of the device application software management service comprises: downloading application software; wherein input information of downloading the application software comprises at least one of the follows: a device identifier, a software version, a software name and a software packet uniform resource locator; and return information of downloading the application software comprises: a response type;
the management operation or capability of the device application software management service comprises: installing application software; wherein input information of installing the application software comprises at least one of the follows: a device identifier, a software version and a software name; and return information of installing the application software comprises at least one of the follows: a response type and an installation state;
the management operation or capability of the device application software management service comprises: deleting application software; wherein input information of deleting the application software comprises at least one of the follows: a device identifier, a software version and a software name; and return information of deleting the application software comprises at least one of the follows: a response type and an installation state;
the management operation or capability of the device application software management service comprises: activating application software; wherein input information of activating the application software comprises at least one of the follows: a device identifier, a software version and a software name; and return information of activating the application software comprises at least one of the follows: a response type, and an activation state;
the management operation or capability of the device application software management service comprises: deactivating application software; wherein input information of deactivating the application software comprises at least one of the follows: a device identifier, a software version and a software name; and return information of deactivating the application software comprises at least one of the follows: a response type, and an activation state.

6. (canceled)

7. (canceled)

8. (canceled)

9. (canceled)

10. (canceled)

11. The method as claimed in claim 1, wherein the management operation or capability of the device application software management service comprises: reporting an application software state; wherein
input information of reporting the application software state comprises at least one of the follows: a final reporting mark, a sequence number, an application software reporting list and an aggregation strategy;
the application software reporting list comprises one or more application software reports, and each application software report comprises at least one of the follows: a group identifier, a device identifier, a management operation, an operation result, an installation state and an activation state;
the management operation comprises at least one of the follows: downloading application software, installing application software, deleting application software, activating application software, and deactivating application software; and
return information of reporting the application software state comprises: a response type.

12. The method as claimed in claim 5, wherein
the installation state comprises at least one of the follows: installation success, installing, installation failed, deletion success, deleting, and deletion failed.

13. The method as claimed in claim 5, wherein
the activation state comprises at least one of the follows: activation success, activating, activation failed, deactivation success, deactivating, and deactivation failed.

14. The method as claimed in claim 1, wherein receiving the management operation or capability of the device application software management service requested by the application entity comprises:
adapting the management operation or capability of the device application software management service to a corresponding technical operation of a device management server.

15. The method as claimed in claim 14, wherein the device management server comprises a device management server in an underlying network of a public Internet of things domain or a device management server in other service provider domains.

16. The method as claimed in claim 14, wherein the device management server uses at least one of the following technologies: an extensible messaging and presence protocol (XMPP), a message queuing telemetry transport (MQTT), an open mobile alliance device management protocol (OMA DM), a broadband forum customer premise equipment wide area network management protocol (BBF CWMP), and an open mobile alliance lightweight machine to machine protocol (OMA lightweight M2M).

17. A device for providing a device application software management service in Internet of things, comprising:
a managing module, arranged to receive a management operation or capability of a device application software management service requested by an application entity, and manage a requested target device according to the management operation or capability of the device application software management service; and
a feedback module, arranged to provide the application entity with an operation result and/or an operation state
wherein
the target device comprises at least one of the follows: a single device, multiple devices indicated in a list, and a device group;
the managing module is further arranged to: execute the management operation or capability of the device application software management service based on scheduling;
a message exchange mode used by the management operation or capability of the device application software management service comprises at least one of the follows: a requesting and responding mode of receiving a request and sending a response synchronously; and a requesting and asynchronously informing mode of reporting to the application entity after an operation is completed.

18. (canceled)

19. (canceled)

20. The device as claimed in claim 17, wherein the managing module is further arranged to adapt the management operation or capability of the device application software management service to a corresponding technical operation of a device management server.

21. The device as claimed in claim 20, wherein the device management server comprises: a device management server in an underlying network of a public Internet of things domain or a device management server in other service provider domains.

22. A system for providing a device application software management service in Internet of things, comprising:
an application entity, arranged to request a management operation or capability of a device application software management service; and
a general service entity, arranged to receive the management operation or capability of the device application software management service requested by the application entity, manage a requested target device according to the management operation or capability of the device application software management service; and provide the application entity with an operation result and/or an operation state;
wherein
the target device comprises at least one of the follows: a single device, multiple devices indicated in a list, and a device group
the general service entity is further arranged to execute the management operation or capability of the device application software management service based on scheduling;
a message exchange mode used by the management operation or capability of the device application software management service comprises at least one of the follows: a requesting and responding mode of receiving a request and sending a response synchronously; and a requesting and asynchronously informing mode of reporting to the application entity after an operation is completed.

23. The system as claimed in claim 22, further comprising:
a management adapter, arranged to adapt the management operation or capability of the device application software management service to a corresponding technical operation of a device management server.

24. The method as claimed in claim 11, wherein
the installation state comprises at least one of the follows: installation success, installing, installation failed, deletion success, deleting, and deletion failed.

25. The method as claimed in claim 11, wherein
the activation state comprises at least one of the follows: activation success, activating, activation failed, deactivation success, deactivating, and deactivation failed.

26. The device as claimed in claim 17, wherein
the management operation or capability of the device application software management service comprises: obtaining application software information; input information of obtaining the application software information comprises: a device identifier; and return information of obtaining the application software information comprises at least one of the follows: a response type, a software version, a software name, a software packet uniform resource locator, an installation state and an activation state;
the management operation or capability of the device application software management service comprises: downloading application software; wherein input information of downloading the application software comprises at least one of the follows: a device identifier, a software version, a software name and a software packet uniform resource locator; and return information of downloading the application software comprises: a response type;
the management operation or capability of the device application software management service comprises: installing application software; wherein input information of installing the application software comprises at least one of the follows: a device identifier, a software version and a software name; and return information of installing the application software comprises at least one of the follows: a response type and an installation state;
the management operation or capability of the device application software management service comprises: deleting application software; wherein input information of deleting the application software comprises at least one of the follows: a device identifier, a software version and a software name; and return information of deleting the application software comprises at least one of the follows: a response type and an installation state;
the management operation or capability of the device application software management service comprises: activating application software; wherein input information of activating the application software comprises at least one of the follows: a device identifier, a software version and a software name; and return information of activating the application software comprises at least one of the follows: a response type, and an activation state;
the management operation or capability of the device application software management service comprises: deactivating application software; wherein input information of deactivating the application software comprises at least one of the follows: a device identifier, a software version and a software name; and return information of deactivating the application software comprises at least one of the follows: a response type, and an activation state.

27. The device as claimed in claim 17, wherein the management operation or capability of the device application software management service comprises: reporting an application software state; wherein
input information of reporting the application software state comprises at least one of the follows: a final reporting mark, a sequence number, an application software reporting list and an aggregation strategy;
the application software reporting list comprises one or more application software reports, and each application software report comprises at least one of the follows: a group identifier, a device identifier, a management operation, an operation result, an installation state and an activation state;
the management operation comprises at least one of the follows: downloading application software, installing application software, deleting application software, activating application software, and deactivating application software; and
return information of reporting the application software state comprises: a response type.

28. The device as claimed in claim 26, wherein
the installation state comprises at least one of the follows: installation success, installing, installation failed, deletion success, deleting, and deletion failed;
the activation state comprises at least one of the follows: activation success, activating, activation failed, deactivation success, deactivating, and deactivation failed.

29. The device as claimed in claim 27, wherein
the installation state comprises at least one of the follows: installation success, installing, installation failed, deletion success, deleting, and deletion failed;
the activation state comprises at least one of the follows: activation success, activating, activation failed, deactivation success, deactivating, and deactivation failed.

30. The device as claimed in claim 20, wherein the device management server uses at least one of the following technologies: an extensible messaging and presence protocol (XMPP), a message queuing telemetry transport (MQTT), an open mobile alliance device management protocol (OMA DM), a broadband forum customer premise equipment wide area network management protocol (BBF CWMP), and an open mobile alliance lightweight machine to machine protocol (OMA lightweight M2M).
